(19) United States
(12) Patent Application Publication
(10) Pub. No.: US 2007/0239513 A1
(43) Pub. Date: Oct. 11, 2007

(54) System and method for employee recruitment, management and reporting

(76) Inventors: Milan Vlanjic, Montgomery Village, MD (US); Angela Houchens, Richmond, VA (US); Paul Mastin, Manassas, VA (US); Jeff Bordogna, Marmora, NJ (US); Michael Gibson, Pensacola, FL (US); Garth Wermter, Gordonsville, VA (US)

Correspondence Address: FREDERICK BAILEY, 11317 NANCYANN WAY, FAIRFAX, VA, 22030, US

(21) Appl. No.: 11/727,236

(22) Filed: Mar. 26, 2007

Related U.S. Application Data
(60) Provisional application No. 60/786,034, filed on Mar. 27, 2006.

(51) Int. Cl. G06F 9/46

(52) U.S. Cl. 705/9

(57) ABSTRACT

A system and method for employee recruitment, management and reporting that includes providing a listing on a website related to open job positions. An applicant applies for an open job position by completing a HTML form. The completed form is submitted to a SQL database using a VBScript and stored. The database contains information on applicants and employees. A user provides a password to access different management menus based on rights associated with the user. The use can manage the information on applicants and employees using the management menus including managing the open job listing, applicant recruitment, employee information, or generating reports related to the applicants and employees.

This application claims the benefit of U.S. Provisional Patent Application No. 60/786,034, filed Mar. 27, 2006, the content of which is expressly incorporated by reference herein in its entirety.

### BACKGROUND

1. Field of the Invention

This invention relates to gathering and managing information, and more specifically to gathering and managing information related to employee recruitment.

2. Description of the Related Art

Employee recruiting is cumbersome for both applicants as well as recruitment staff at companies. Applicants must search for and sort through various sources of information in order to identify a job opening that may be of interest. Further, recruitment personnel must manually read resumes and other information to identify potential candidates to fill job openings that they may have.

Therefore, there is a need for a system and method for employee recruitment, management and reporting that streamlines pre-existing workflows for entities or company recruitment staff as well as applicants.

### SUMMARY OF THE INVENTION

A system and method for employee recruitment, management and reporting that may include two separate but linked and integrated websites modules, a public side module and a private side module. The modules may reside on separate or the same server or network device. Both modules may integrate with a single Microsoft (MS) Structured Query Language (SQL) database. The public side module provides applicant entry into the system over a public network (e.g. the Internet), as well as a read-only listing of available positions. The private side module provides password-protected management entry into the system. Through the private side, positions, applicants, employees, travel, schools, and users can be reviewed, modified, sorted, searched, collated and/or reported upon. The automation of data searches and report creation may be achieved through the integration of Personal Home Page (PHP) scripts and SQL statements with the SQL database. Embodiments according to the present invention may be particular useful in government-related employee recruitment, management and reporting due to the abundance of government agencies and entities and the extremely large amount of potential and existing employees.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for employee recruitment, management and reporting according to an example embodiment of the present invention;

FIG. 2 is a flowchart of a public side interface process according to an example embodiment of the present invention;

FIG. 3 is a flowchart of a private side interface process according to an example embodiment of the present invention; and

FIG. 4 is a diagram of a flowchart of a process for employee recruitment, management and reporting according to an example embodiment of the present invention.

### DETAILED DESCRIPTION

The particulars shown herein are by way of example and for purposes of illustrative discussion of the embodiments of the present invention. The description taken with the drawings makes it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Embodiments of the present invention relate to efficient employee recruitment, management and reporting systems and methods. In one example embodiment the system implements an ARMY Reserve Officer Training Corps (ROTC) Recruitment Information System (RIS). The RIS may be based on a central Microsoft SQL database and streamlines pre-existing workflows for company recruitment staff as well as applicants. This example embodiment will be used to help illustrate the present invention. However, the present invention is not limited to this embodiment.

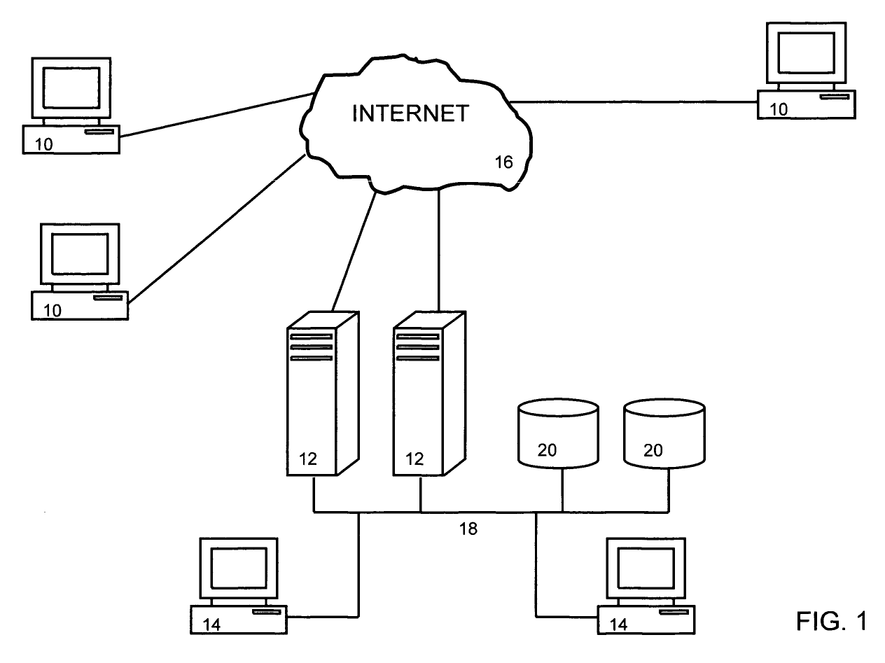

FIG. 1 shows a diagram of a system for employee recruitment, management and reporting according to an example embodiment of the present invention. The system may include one or more user devices 10, at least one server 12, one or more administrator devices 14, and one or more storage devices 20. The user devices are capable of accessing the Internet 16. The one or more servers 12 are operatively connected to the Internet 16 and to the one or more administrator devices 14. The one or more servers 12, the one or more storage devices 20, and the one-or more administrator devices may be interconnected via a bus 18. The one or more storage devices 20 may contain a database such as, for example, a SQL database.

Applicants can use the user devices to access a recruitment website located on the servers 12 via the Internet 16. This allows the applicants to view all open positions as well as details regarding these positions. The positions may be organized in many different ways or a combination thereof such as for example, type (e.g., full-time, part-time, etc.), category or job title (e.g., professor positions, administrative positions, specialist positions, officer positions, etc.), school, city, state, geographic region, effective date, etc. The applicants may apply for one or more of the open job positions by completing an application interface of the website. The completed applications may then be received by the one or more servers 12 and stored in the storage devices 20. Administrators may then use an administrator device 14 to access the servers 12 and storage devices 20 and perform various types of processing on the completed applications. The user devices 10 and the administrator devices 14 may be any type of device capable of accessing a server or the Internet such as, for example, a computer, workstation, Personal Digital Assistant (PDA), mobile phone, etc.

According to embodiments of the present invention, applicant/recruit management and employee management are combined into an integrated system. The provides the ability to hire an employee, as well as the ability to demote an active employee back to applicant status, or even to a third or fourth status (such as leave of absence, terminated, etc.).

Moreover, embodiments according to the present invention provide the ability to track employees and/or personnel. For example, consider the scenario of a nursing recruiter that wants to track its pool of available traveling nurses. These nurses may typically work 13-week stints at a given location, and then have the option of staying there, moving to another job, or taking 13 weeks off. These nurses may have unique IDs or codes that relate to each nurses' status and that may be stored. Modification of these codes based on current status allows the system to track these nurses. Further, embodiments of the present invention may be applicable in applications in government and law enforcement, too, where tracking the status of an individual on a watchlist may be desired, and where a person's status may be changeable from one status to another.

In addition, embodiments according to the present invention provide the ability to independently track two separate keyed items, for example, positions and people. The system may track a history of status codes for interactions between positions and people. When a person applies for a position, a timestamp and status id may be ascribed to both the position and the person. The same may exists when a person is hired, goes on LOA, etc. In this way, the status of a person or position can be usefully tracked, and even cross-referenced.

To help illustrate the present invention, portions of the system related to the applicants may be referred to as a public side interface or website and portions of the system that relate to the administrators and system management may be referred to as a private side interface or website. Both portions may reside on a single server or be resident on different or multiple servers.

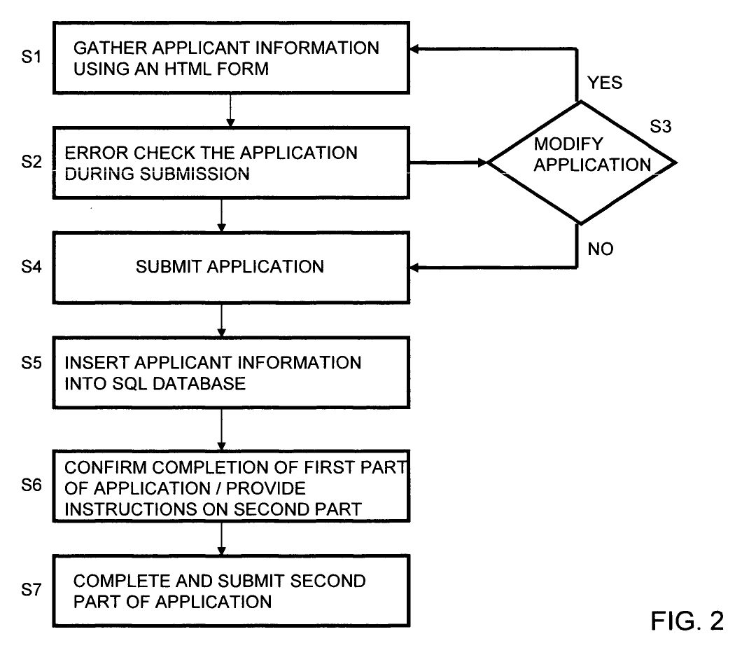

FIG. 2 shows a flowchart of a public side interface process according to an example embodiment of the present invention. This process may operate on a server 12 or other processing device and may be accessible via a network such as the Internet 16. In one example embodiment, the public side interface of a RIS may include a scripting language (e.g., virtual basic script (VBScript)) that interfaces with a Microsoft SQL database to dynamically list open job positions. An applicant is able to view all open positions by position type. Applicants may apply for positions using a Hypertext Markup Language (HTML) form submitted to a SQL database (e.g., MSSQL database) with VBScript. The applicants may also provide a Word document or other information submitted by mail or email.

The positions listing page may use a VBScript that generates a SQL select call and compares filled positions with authorized positions to determine open positions. All open positions may be listed by position type. An applicant can identify a desired position type and position and click on an associated link to begin the application process.

For example, an applicant may initially browse the list of current openings that is found on the public website. The list of open positions may be generated from the database and may be grouped by the type of position. A position is considered open if it is vacant, the employee currently in the position is leaving, or a manual override in the application has been triggered for the position. Under each group of positions on the website, there is a link to the on-line application. Once applicants arrive at the on-line application, they are presented with several fields to complete, some of which are required, some of which are optional. After the application has been submitted, the information is inserted into the database, the applicant may be sent an e-mail receipt of his or her application, and a notice may be sent to several individuals to inform them of the new application.

The applicant may then see a page with instructions for completing their application packet. This page may contain a list of all required documents, as well as links to the relevant forms for applicants to print out and complete. The applicant can either mail all of the documents to the specified address, or e-mail them to the specified e-mail address. Further, these documents may be received through the website.

Therefore, the application process includes gathering applicant position, state, and school preferences and other basic information using an HTML form presented to the applicant (S1). During the application submission process, the application may be error checked (S2). The error checking may be performed using a JavaScript. The applicant may be redirected to a confirmation page where the applicant can modify or submit the application. If the applicant chooses to modify (S3), the applicant may be redirected back to the HTML application with all previously submitted information filled in. If the applicant chooses to submit the application (S4), the applicant may be redirected to the next part of the application process. Once submitted, a VBScript may be used to insert the applicant information into a SQL database (S5).

Moreover, as noted previously, the application process may include a second part. The second part of the application process may confirm completion of the first part and instruct the applicant on completing the second part (S6). Applicants may be instructed to download and complete the second part of the application (which may be available in a particular format such as, for example, MS Word format). The second part of the application process and other supporting documentation can then be submitted (S7) by some method, for example, mail or email, as instructed on the webpage to complete the application process.

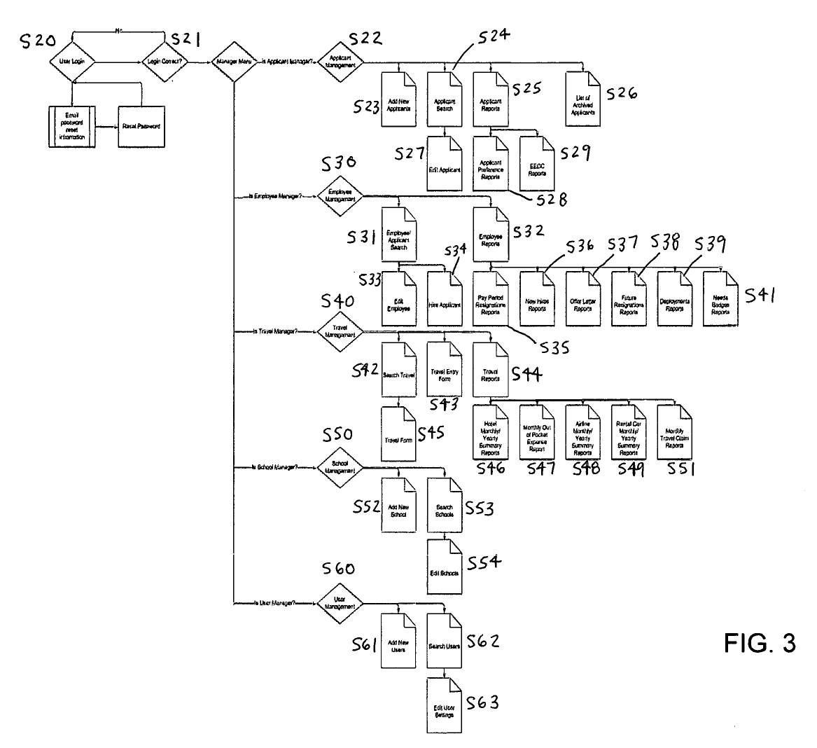

FIG. 3 shows a flowchart of a private side interface process according to an example embodiment of the present invention. This process may operate on a server 12 or other processing device and may be accessible via a network such as the Internet 16. In this example embodiment, a Recruitment Information System may present an administrator or user with a login option (S20) where the user may enter a password or other information for entry into the system. The password may be verified for correctness before allowing entry into the system (S21). The system may present the user with several options based on user rights of the user. Different menus may be generated and managed by different processing modules and may be displayed for a given user, for example, menus for: applicant management (S22), employee management (S30), travel management (S40), school management (S50), user management (S60), etc. User rights information may be stored in a database, for example, in a Microsoft SQL Server database and retrieved, for example, using PHP scripts and SQL statements.

For example, after an application has been submitted, the data is inserted into the database, and the applicant becomes available in an Applicant Management Module. To view new applicants, the administrator or user may select an Incomplete Applications menu option. This page allows applicants to be searched, sorted, and filtered according to a variety of criteria. The search results may contain a link to view all of an applicant's data, the status of their paperwork, as well as the option to delete the application from the system. Once an applicant has been selected, a window may display all of this applicant's information. This page may provide access to the applicant's nomination status, their personal information, all of the documents in their packet through an Upload Center, and the status of the application, including the option to mark the application as complete or incomplete. Once an applicant's packet is marked as completed, they may be nominated into an open position.

Applicants can be nominated to several positions and several applicants can be nominated to one position. Nomination simply indicates that an applicant is being considered for a position, but has not yet been hired to this position. Nomination allows users to match applicants to positions for which they are qualified. An applicant can be nominated from either their application or from a Nominate Applicant menu option. A following page may contain a list of positions for which the applicant can be nominated. An applicant may be nominated to multiple positions by holding down a key while selecting positions. After selecting a Nominate button, the user may be prompted to explain the status change, thus creating a record of this person's nomination in the log. Once the log details have been submitted, the nomination will be complete, and the application will be updated to reflect these changes. An applicant's nomination status may be modified from their main application page.

Following an applicant nomination, the applicant can be hired into this position. This may occur in an Employee Manager module. There are several administrative functions that the Applicant Management Module may perform. For example, old applications may be archived. Over the course of time, stale applications may need to be pruned from the system. To accommodate this need, an application can be archived. To archive an applicant, an Archive option may be selected from an applicant search results page. Once it has been archived, it may be no longer accessible from Complete Applications or Incomplete Applications menu options. Archived applications may be accessed from an Archived Applicants menu option.

An Applicant Management Module may also perform tasks related to adding applicants to the system. For a variety of reasons, a potential applicant may not be able to complete the online application. Through a Blank Application menu option, a blank application can be printed and mailed to a potential applicant. After this application has been received by management staff, it can be entered into the system through a New Applicant menu option. The application is now in the database, and can be searched and sorted just as every other application. Another administrative task that an Administrative Management Module may perform includes generating reports. The reporting capabilities of the system may be available through an Applicant Reports menu option. After selecting the respective options for the desired report and selecting a Generate Report option, the report will appear in the web browser. From this screen the report can be printed, or exported to a spreadsheet document for further manipulation. An applicant's status may also be changed or transferred. For example, the system provides the capability to transfer an applicant from the status of recruit to the status of employee, and vice-versa.

Therefore, if applicable, i.e., user has appropriate user rights, an applicant management option menu may be presented to the user (S22). Within this menu, as noted previously, submenu options may be available that may include, for example, an option to manually add a new applicant (S23), search through existing applicants (S24), view applicant reports (S25), and review a list of archived applicants (S26). The new applicant entry page may mirror the information provided on the public side interface, allowing a user or company applicant manager the ability to enter a new applicant manually. The applicant search option (S24) offers an applicant manager the ability to enter a search criteria and search, review and edit active applicants (S27). An applicant reporting option (S25) may provide a user or manager access to several applicant reports (S28) that may have been generated, as well as other reports such as Equal Employment Opportunity Commission (EEOC) reports (S29). The generated reports may be standard reports or customized reports based on options selected by the user. The list of archived applicants (S26) provides a user with access to applicants whose applications have been archived for some reason.

An Employee Management Module may allow users access to employee information in the database. The module may include functions such as, for example, employee information management, employee hiring, and reporting. For organizational purposes, employees may be divided into categories such as, for example, billable and non-billable. The module's menu may reflect this distinction. A data management interface may be identical for billable and non-billable employees. Within the Employee Management Module, employees can be searched and sorted by their last and first names, school, employee number, and position type.

Employees may be tracked using employee status codes. These status codes may be used to distinguish between active and inactive employees for the purposes of tracking filled and available positions. Every position change may be logged, thus users may not be able to directly change an employee's assigned position. Position changes may be facilitated by transferring an employee to a new position by selecting a “Transfer” option from an employee status dropdown menu. The employee may then be transferred to the specified position.

Employee information may be divided into separate categories such as, for example, “Employee Data” that contains personal, contact, and basic employment information. Users can update the information contained in the fields on this page, saving their changes using a “Submit” button. Another category of information may be “History”, which may be essentially a log of the various personnel actions for a given individual. This history is specific to an individual not a given instance of employment. Within this page, users can view, edit, delete, and add new personnel action records. Employee managers may be prompted to create a history entry whenever an employee's status is changed.

A “Compensation” option may provide users access to current and historic salary and incentive data. Users can view, edit, delete, and add new salary and incentive information on this page. A “Demographics” option may allow access to detailed information about the employee, including, for example, demographics, offer letters, badges, Employee.net, NAC/NAC-LC, and unit data. A miscellaneous information tracker may allow users to track information about an employee's driver's licenses, APFT scores, performance evaluations, and CAC cards. Users may track an employee's health insurance claims through a Tricare tracker.

Moreover, employee managers may view, edit, add, and delete miscellaneous notes for an employee through a “Notes” option. Users have the ability to hire nominated applicants through a “Hire an Employee” menu option. The Employee Management Module allows users to search or browse through all applicants who have been nominated for various positions. Once an applicant has been selected, the user may select the projected hire date. This date determines when an applicant will be processed by the system and become an employee. Until the date of hire, the employee's position may be considered vacant. The hire function may also log the date of the status change and allow users to enter comments regarding the status change. After this form has been submitted, the applicant may be submitted to the system for processing.

The Employee Management Module may also include a number of reporting capabilities. The reporting capabilities of the system may be available through an Employee Reports menu option. After selecting the respective options for the desired report and selecting a Generate Report option, the report will appear in the web browser. From this screen the report can be printed, or exported to a spreadsheet document for further manipulation.

Therefore, if applicable, an employee management menu option (S30) may be presented to the user. Within this menu, submenu options may include, for example, options for an employee or applicant search (S31) and employee reports (S32). The employee/applicant search option (S31) provides a user access to employee information and provides the user with the ability to edit employee information (S33), including demographics, residence, and position, as well as the ability to hire an applicant into a position (S34). The employee reports option (S32) provides a user with access to reports, including reports related to resignations (S35), new hires (S36), offer letters (S37), future resignations (S38), deployments (S39), and needs badges (S41). This information may be retrieved from a Microsoft SQL database using PHP scripts and SQL statements.

If applicable, a travel management menu option (S40) may be presented to the user. Within this menu, submenu options may be presented that may include, for example, a travel search option (S42), travel entry option (S43), and travel reports (S44). The travel search option menu (S42) provides the user the ability to query a database using PHP scripts and SQL statements in order to review past travel information. A travel entry form (S45) provides the user the ability to enter new travel information, and access travel reports that may include several travel summary reports.

The travel reports submenu option (S44) may provide access to more detailed travel reports such as for example, reports related to hotel monthly/yearly summaries (S46), monthly out of pocket expenses (S47), airline monthly/yearly summaries (S48), rental car monthly/yearly summaries (S49), and monthly travel claims (S51).

A School Management Module allows users to add, edit, and delete school information that may be used globally in the application. Information modified or removed here may be tied to other records within the database, therefore modifications may possibly result in other data corruption. Schools can be searched by FICE code, school name, city, and state. Each school may be either a primary school or a partnership school. If a school is a partnership school, it may have a primary school listed as its host school. The region setting may be of particular importance since its parental relationship with positions and employees may determine the region of the positions at that school, and in turn the region of the employees who occupy those positions.

Therefore, if applicable, a school management menu option (S50) may be presented to the user. Within this menu, submenu options may be provided which include, for example, a school entry menu (S52) and a school search option (S53). The school entry function associates a new school and Federal Interagency Committee on Education (FICE) code. The school search function provides entry into the existing school list in the database, along with the subsequent ability to edit an existing school's entry in the database (S54).

A User Management Module may allow users to assign access rights and modify usernames and passwords within the system. User managers can also add new users to the system from within this module. Permissions may be module-based, with further breakdowns based on region for the recruiting and region managers.

Therefore, if applicable, a user management menu option (S60) may be presented to the user. This menu may provide submenus allowing the user with the ability to add new users (S61) and search users (S62) to assign rights within the system to existing users or edit user settings (S63).

Although not shown, other management modules may be included in embodiments according to the present invention such as recruiting management, region management, expense management, and position management.

A Recruiting Management Module allows users access to applicant information in the database. Applicants who have fully completed the application process will appear in this module. The Recruiting Management Module allows users to view and nominate applicants and to make limited changes to the personal information of each applicant. The ability to edit all information related to an applicant may be reserved for applicant managers. A View/Edit Applicants option of the Recruiting Management Module provides a user the ability to search, sort, and browse all active applicants. Applicants can also be searched based on position, school, or state preferences submitted in their application. A maximum of preferences may be set and used.

Once an applicant has been selected, a window may display all of their personal information. Certain fields may be edited/updated by Recruiting Managers. If a field is white, it is editable, whereas, if a field is gray, it may have been disabled and the data may only be changed by Applicant Mangers. Recruiting managers may only have access to applicants who specified preferences within their respective region. Through a Nominate Applicant option Recruiting Managers may be given the ability to nominate an applicant for one or more positions. Applicants may be searched by first or last name, social security number, school, nominated position, or current status. To search for an individual who has already been nominated for a position, a search may be specified by choosing either a region, for example, ‘nominated east’ or ‘nominated west’. It is also possible to search the entire database by simply clicking a ‘search all’ option.

To select an applicant, their highlighted last name may be selected. The screen may display a list of positions that an applicant can be nominated against. To nominate an applicant for more than one position, buttons may be used to select the various positions. Once an applicant has been nominated, the system may log the date and nomination. Managers may only be allowed to modify nominations within their own region. For example, if an individual is a recruiting manager for an east region, he/she may not be able to modify nominations made by a west recruiting manager.

A View Archived Applicants option may display a list of applicants that are no longer considered active applicants. Choosing the option may display a list of all archived applicants, including: the applicants name, the date that the application was submitted, the date the applicant is available for work, and a comment field. The comment field may be used to classify the status of the archived applicant and any other brief comments. For a variety of reasons, a potential applicant may not be able to complete the online application. As noted previously, through a View Blank Application option, a blank application may be printed and mailed to a potential applicant. Another option of the Recruiting Management Module, Applicant Reports, allows Recruiting Managers to view applicants based on position type, state, or region and nominations by region. These demographic reports may be printed or exported to a spreadsheet document for further manipulation.

A Region Management Module provides region managers the ability to add and update various pieces of information about employees. Region managers' access may be restricted to employees in their designated region. For organizational purposes, employees may be divided into categories, such as, for example, billable and non-billable. The data management interface may be identical for billable and non-billable employees. The module's menu may reflect this distinction. Within the Region Management Module, employees may be searched and sorted by their last and first names, school, employee number, and position type.

Employees may be tracked using employee status codes. These status codes may be used to distinguish between active and inactive employees for the purposes of tracking filled and available positions. Region managers may not be able to modify the employee status codes or position information. Employee information may be divided into separate categories. For example, an “Employee Data”, may contain personal, contact, and basic employment information. Users can update the information contained in the fields on this page, saving their changes using a “Submit” option. Another category of information, “History”, may be essentially a log of the various personnel actions for a given person. Within this page, users can view existing personnel action records. This history is specific to an individual not a given instance of employment.

A “Compensation” option may only be available to users who are designated as region managers, not region staff. This option may provide region managers access to current and historic salary and incentive information. A “Demographics” option may allow access to detailed information about the employee, including: demographics, offer letters, badges, Employee.net information, NAC/NAC-LC, and unit data. Region managers and staff may be allowed to modify selected fields in this section. A miscellaneous information tracker may allow region managers to add, edit, and remove information about an employee's driver's licenses, APFT scores, performance evaluations, and CAC cards. Region managers and staff can view an employee's Tricare claims through a Tricare tracker, but may not be able to add or modify claims. Further, region managers may view, edit, add, and delete miscellaneous notes for an employee through a “Notes” option.

An Expense Management Module allows users to track expenses that are reported by individuals while on company business. Expense tracking is not limited to employees. Expenses may be tracked for any individual within the system. The system's tracking capabilities may include, for example, travel, out of pocket, and parking or moving expenses. Within the Expense Management Module, individuals can be searched and sorted by their last and first names and social security number. Once an individual has been selected, all of their existing expenses may be displayed. From this screen, users may add, remove, and edit expenses.

Users may also track a variety of information about each expense. Certain fields, including contract data and various dates associated with the expense, may be available for all expense types. Users may also track more specific data for travel expenses, such as airline and rental car information. The Expense Management Module may be capable of generating several types of reports. These may be available through an Expense Reports menu option. After selecting the respective options for the desired report and selecting a Generate Report option, the report will appear in the web browser. From this screen the report can be printed, or exported to a spreadsheet document for further manipulation.

Users may control the available positions in the system through a Position Management Module. Within this module, users can add, edit, and remove positions, as well as track a variety of information about the positions. The module may also generate a staffing directory report, i.e., a comprehensive list of all positions. Users may have several options from within the position manager such as, for example, they may add, edit, and remove positions, as well as process an imported J-document. There may be several fields in the position manager. For example, an “Effective Date” field may control the date displayed on the public website. If the date specified is in the future, the date may be shown. If the date is in the past, then the word “Immediate” may be displayed.

The position manager may also indicate the status of the position. If the position is considered open by the system, it is advertised on the website. If it is not open, it is not advertised. A position may be considered open by the system if no active employee is assigned to that position. An advertisement setting may be overridden in the system using an “Override Advertise Setting” field. For example, if a position is not displayed, toggling this field may force the position to be displayed.

The J-document may be a spreadsheet document that is periodically obtained from the government. This spreadsheet contains a list of all the positions and position types that the government has authorized. This document may be imported on the server using a windows application that compares the authorized positions from the J-document with those present in the database. It creates a list of positions changes for the management application to process. When this option is selected, the user is presented with a list of potential changes. After the user has selected which changes to apply, the system creates any new positions. Then, the system may check for any position deletions. If a matching position is unoccupied, it may be removed automatically. If a matching position is filled, the user may be prompted to select which position(s) to remove. The user may be prompted to change the status of any employee affected by the position changes. The Position Management Module may generate a “Staffing Directory Report”. This report is a comprehensive listing of all employees and positions, and may be automatically opened as a spreadsheet document.

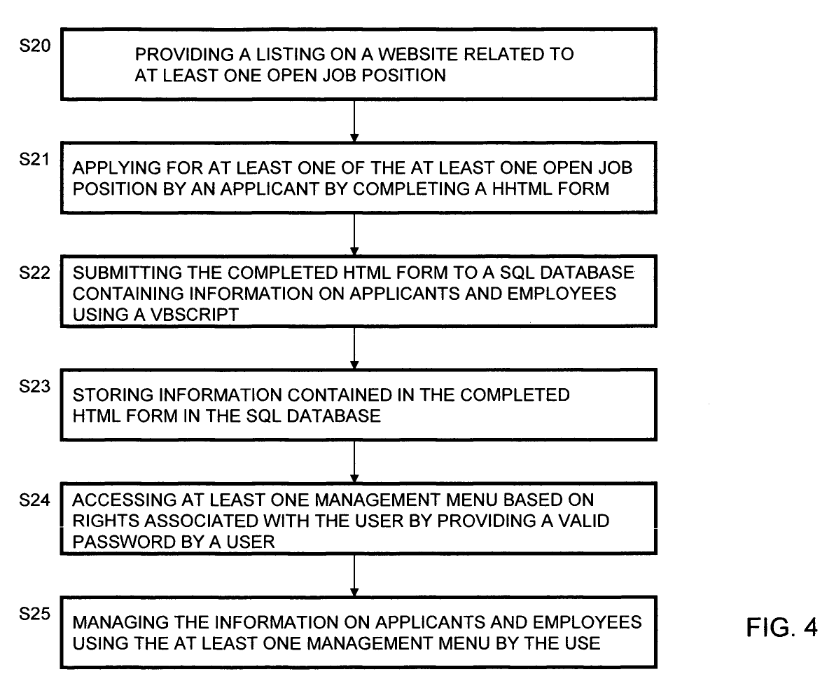

FIG. 4 shows a diagram of a flowchart of a process for employee recruitment, management and reporting according to an example embodiment of the present invention. A listing is provided on a website related to open job positions (S20). An applicant applies for one or more of the open job positions by completing a Hypertext Markup Language (HTML) form (S21). The completed HTML form is submitted to a SQL database using a virtual basic script (VEBScript). The database contains information on applicants and employees (S22). The information contained in the completed HTML form is stored in the SQL database (S23). One or more management menus are accessed by a user by providing a valid password (S24). Each management menus provides the user with access based on rights associated with the user (S24). The information on applicants and employees is managed by the user using the management menus (S25). The managing may include managing the open job listing, managing applicant recruitment, managing employee information, and/or generating reports related to the applicants and employees. The management menus may include an applicant management menu, an employee management menu, a travel management menu, a school management menu, or a user management menu.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A system for employee recruitment, management and reporting comprising:
a public network;
at least one applicant device, the at least one applicant device being capable of accessing the public network;
at least one server, the at least one server providing a public website over the public network and a private website with restricted access; and
at least one user device, the at least one user device operatively connected to the at least one server,
wherein applicants can use the at least one applicant device to access the public website allowing the applicants to view open job positions and apply for the open job positions by submitting applicant information, the private website providing access to users via the at least one user device to different menus based on user rights owned by each individual user, the different menus being related to employee recruitment, management, and reporting.

2. The system according to claim 1, further comprising at least one storage device, the at least on storage device containing a SQL database, a visual basic script (VBScript) being used to insert the applicant information into the SQL database.

3. The system according to claim 2, wherein the applicants apply for the open job positions using a Hypertext Markup Language (HTML) form submitted to the SQL database with VBScript.

4. The system according to claim 1, wherein a VBScript generates a SQL select call and compares filled positions with authorized positions to determine the open job positions.

5. The system according to claim 1, wherein the public network comprises the Internet.

6. The system according to claim 1, wherein the open job positions are organized on the public website by at least one of type, category, school, city, state, geographic region, or effective date.

7. The system according to claim 1, wherein the private website requires a password from the user for access to the different menus.

8. The system according to claim 1, wherein the different menus comprise at least one of an applicant management menu, an employee management menu, a travel management menu, a school management menu, or a user management menu.

9. The system according to claim 8, wherein the applicant management menu comprises at least one submenu comprising at least one of an option to manually add a new applicant, an option to search through existing applicants, an option to view applicant reports, or an option to review a list of archived applicants.

10. The system according to claim 9, wherein the applicant search option comprises an option to enter a search criteria and search, review and edit active applicants.

11. The system according to claim 9, wherein the applicant report option comprises at least one of an option to access applicant reports or Equal Employment Opportunity Commission (EEOC) reports.

12. The system according to claim 8, wherein the employee management menu comprises at least one submenu comprising at least one of options for an employee or applicant search or employee reports.

13. The system according to claim 12, wherein the employee search option comprises at least one option of allowing a user access to employee information for editing employee information or options for hiring an applicant into a position.

14. According to claim 12, where the employee reports option comprises at least one menu option comprising reports related to resignations, new hires, offer letters, future resignations, deployments, or needs badges.

15. The system according to claim 8, wherein the travel management menu comprises at least one submenu comprising at least one of options for a travel search option, a travel entry option, or travel reports.

16. The system according to claim 15, wherein the travel search option menu comprises a travel entry form that provides the user the ability to enter new travel information, and access travel reports that may include several travel summary reports.

17. The system according to claim 15, wherein the travel reports option comprises options for at least one of reports related to hotel monthly/yearly summaries, monthly out of pocket expenses, airline monthly/yearly summaries, rental car monthly/yearly summaries, or monthly travel claims.

18. The system according to claim 8, wherein the school management menu comprises at least one submenu comprising at least one of options for a school entry menu or a school search option.

19. The system according to claim 18, wherein the school search option comprises an option to edit an existing school's entry in the database.

20. The system according to claim 8, wherein the user management menu comprises at least one submenu comprising at least one of submenus allowing the user the ability to add new users or allowing the user the ability to search users.

21. The system according to claim 20, wherein search users option provides the user with the capability to assign rights within the system to existing users and edit user settings.

22. A method for employee recruitment, management and reporting comprising:
providing a listing on a website related to at least one open job position;
applying for at least one of the at least one open job position by an applicant by completing a Hypertext Markup Language (HTML) form;
submitting the completed HTML form to a SQL database using a virtual basic script (VEScript), the database containing information on applicants and employees;
storing information contained in the completed HTML form in the SQL database;
accessing at least one management menu by providing a valid password by a user, the at least one management menu providing the user with access based on rights associated with the user; and
managing the information on applicants and employees using the at least one management menu by the user, the managing comprising at least one of managing the open job listing, managing applicant recruitment, managing employee information, and generating reports related to the applicants and employees.

23. The method according to claim 22, wherein the at least one management menu comprises at least one of an applicant management menu, an employee management menu, a travel management menu, a school management menu, or a user management menu.

24. The method according to claim 22, wherein the applicant management menu comprises at least one submenu comprising at least one of an option to manually add a new applicant, an option to search through existing applicants, an option to view applicant reports, or an option to review a list of archived applicants.

25. The method according to claim 22, wherein the employee management menu comprises at least one submenu comprising at least one of options for an employee or applicant search or employee reports.

26. The method according to claim 22, wherein the travel management menu comprises at least one submenu comprising at least one of options for a travel search option, a travel entry option, or travel reports.

27. The method according to claim 22, wherein the school management menu comprises at least one submenu comprising at least one of options for al school entry menu or a school search option.

28. The method according to claim 22, wherein the user management menu comprises at least one submenu comprising at least one of submenus allowing the user the ability to add new users or allowing the user the ability to search users.
